(19) United States
(12) Patent Application Publication
(10) Pub. No.: US 2017/0185339 A1
(43) Pub. Date: Jun. 29, 2017

(54) SYSTEM FOR IMPLEMENTING IMPROVED PARITY-BASED RAID METHOD

(71) Applicants: NANNING FUGUI PRECISION INDUSTRIAL CO., LTD., Nanning (CN); HON HAI PRECISION INDUSTRY CO., LTD., New Taipei (TW)

(72) Inventor: YA-CHUN CHUANG, New Taipei (TW)

(21) Appl. No.: 15/054,893

(22) Filed: Feb. 26, 2016

(30) Foreign Application Priority Data
Dec. 28, 2015 (TW) 104144023

(51) Int. Cl. G06F 3/06

(52) U.S. Cl. CPC G06F 3/0631; G06F 3/0607; G06F 3/0653; G06F 3/0689

(57) ABSTRACT

A system for implementing a parity-based redundant array of independent disks (RAID) method includes an electronic device and an m number of disk drives electrically coupled to the electronic device. A file is saved to the m number of disk drives by being written across the m number of disk drives one or more times as a number of data segments and a corresponding number of parity segments. For each time of reading across the m number of disk drives, the electronic device reads an m number of data files. For each time of reading across the m number of disk drives, the electronic device, according to a predetermined reading algorithm, determines the disk drives to which the m number of data segments were written and assembles the number of data segments together according to a predetermined order.

### CROSS-REFERENCE TO RELATED APPLICATIONS

This application claims priority to Taiwanese Patent Application No. 104144023 filed on Dec. 28, 2015, the contents of which are incorporated by reference herein.

### FIELD

The subject matter herein generally relates to a system for implementing an improved parity-based redundant array of independent disks (RAID) method.

### BACKGROUND

Generally, in a parity-based redundant array of independent disks (RAID) method, a file is saved to a plurality of disk drives by striping the file into a plurality of data information and calculating a plurality of parity information of the striped file. The plurality of parity information is used to back up the plurality of data information if the plurality of data information is damaged. The plurality of data information and the plurality of parity information are both saved across the plurality of disk drives. To read the file, the plurality of data information and the plurality of parity information are both read from the plurality of disk drives, but only the plurality of data information is assembled into the file.

### BRIEF DESCRIPTION OF THE DRAWINGS

Implementations of the present technology will now be described, by way of example only, with reference to the attached figures.

FIG. 1 is a block diagram of an embodiment of a system for implementing a parity-based redundant array of independent disks (RAID) method.

FIG. 2 is a diagrammatic view of a process of saving a plurality of data segments and a plurality of parity segments across an m number of disk drives.

FIG. 3 is a flowchart of an embodiment of a method for implementing the parity-based RAID method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

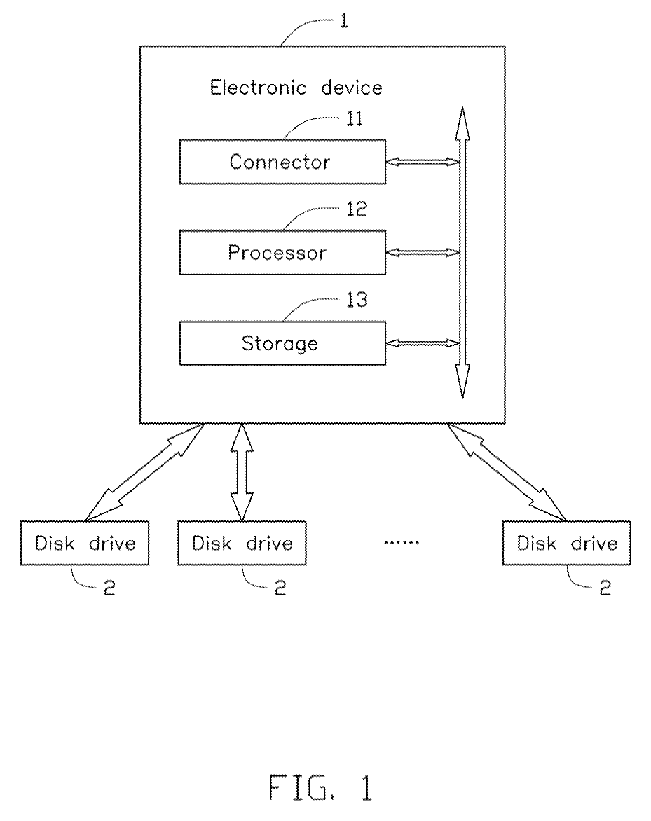

FIG. 1 illustrates an embodiment of a system for implementing a parity-based redundant array of independent disks (RAID) method. The system can include an electronic device 1 and an m number of disk drives 2 electrically coupled to the electronic device 1. The electronic device 1 can include a connector 11, a processor 12, and a storage 13. The connector 11 can be used for coupling the electronic device 1 to the m number of disk drives 2. In at least one embodiment, the electronic device 1 can implement the parity-based RAID method through a RAID control card, through a RAID program executed by the processor 12, or the like. In at least one embodiment, the connector 11 can be a SATA port or the like. The processor 12 can execute functions of the electronic device 1. In at least one embodiment, the processor 12 can be a control chip of the RAID control card or a central processor of the electronic device 1. The storage 13 can be used for storing the plurality of functions of the electronic device 1 and for storing a plurality of data segments of a file to be written across or read from the m number of disk drives 2.

To write the file across the m number of disk drives 2, the electronic device 1 implementing the parity-based RAID method divides the file into a plurality of data segments and calculates a corresponding plurality of parity segments according to the plurality of data segments. The plurality of parity segments can be calculated according to a default algorithm. For each time of writing across the m number of disk drives 2, the electronic device writes an n number of the plurality of parity segments and an m−n number of the plurality of data segments across the m number of disk drives 2. The electronic device 1 calculates, according to a predetermined writing algorithm, which of the m number of disk drives 2 to write the m−n number of data segments and the corresponding n number of parity segments. To read the file from the m number of disk drives 2, the electronic device 1 determines, according to a predetermined reading algorithm, which disk drive 2 of the m number of disk drives 2 to which each of the plurality of data segments were written and assembles the plurality of data segments together into the file. For each time of writing across the m number of disk drives 2, the electronic device 1 writes a corresponding m−n number of data segments, and for each time of reading across the m number of disk drives 2, the electronic device 1 reads a corresponding m number of data segments. Thus, a speed of reading the plurality of data segments from the m number of disk drives 2 is increased.

In at least one embodiment, each of the plurality of data segments can have a same predetermined size. In at least one embodiment, the predetermined size is 64 kilobytes. The electronic device 1 can determine whether the size of a last one of the plurality of data segments is less than the predetermined size. If the size of the last one of the plurality of data segments is less than the predetermined size, the electronic device 1 can allocate a plurality of dummy data segments to the last one of the plurality of data segments to make the size of the last one of the plurality of data segments equal to the predetermined size. For example, the plurality of dummy data segments can be of a predetermined format, such as being completely made up of binary 0 data.

Before each time of writing across the m number of disk drives 2, the electronic device 1 can determine whether a remaining number of the plurality of data segments is less than m−n. If the remaining number of the plurality of data segments is less than m−n, the electronic device can allocate a plurality of dummy data segments to the remaining number of the plurality of data segments to make the number of the remaining number of the plurality of data segments equal to m−n. For example, the plurality of dummy data segments can be of a predetermined format, such as being completely made up of binary 0 data.

For each time of writing across the m number of disk drives, the electronic device 1 can calculate the n number of parity segments according to the corresponding m−n number of data segments. In at least one embodiment, the n number of parity segments is calculated according to a default algorithm. For each time of writing across the m number of disk drives 2, the electronic device 1, according to the predetermined writing algorithm, determines which of the m−n number of disk drives 2 to write the m−n number of data segments and which of the n number of disk drives 2 to write the n number of parity segments according to a serial number of a first one of the m−n number of data segments, the m number of disk drives 2, and the n number of disk drives 2. For example, if the file is divided into four data segments D1, D2, D3, and D4, the serial numbers of the data segments are 1, 2, 3, and 4, respectively. The positions of the plurality of data segments stored in the m number of disk drives 2 differ by a predefined file size (64 kilobytes). Thus, by knowing the serial number of the data segments, the positions of the data segments in them number of disk drives 2 can be determined.

In at least one embodiment, the writing algorithm assigns the m−n number of data segments as B1, B2, . . . , Bm−n and assigns the n number of parity segments as P1, P2, . . . , Pn. The writing algorithm also sequences the m number of disk drives 2 from the first disk drive 2 to the mth disk drive 2. B1 represents the first data segment of the m−n number of data segments and corresponds to a first disk drive 2 of a disk drive sequence determined by the writing algorithm. Bm−n represents the m−nth data segment of the m−n number of data segments and corresponds to the m−nth disk drive 2 of the disk drive sequence. P1 represents the first parity segment of the n number of parity segments and corresponds to the m−n+1^{sy} disk drive 2 of the disk drive sequence. Pn represents the nth parity segment of the n number of parity segments and corresponds to the mth disk drive 2 of the disk drive sequence.

For each time of writing across the m number of disk drives 2, the writing algorithm determines which disk drives 2 of the m number of disk drives 2 to write the corresponding m−n number of data segments according to the formula L=(B/(m−n)*n)%(m*n).

In the formula, L represents a number of times of moving left along the disk drive sequence relative to a first disk drive 2 of the disk drive sequence. A position located left of the first one of the m number of disk drives 2 is equal to the m^{th} disk drive 2. B represents the serial number of a first one of the m−n number of data segments to be written across the m number of disk drives 2. M represents the total number of the m number of disk drives 2. n represents the number of the m number of disk drives 2 used for writing the parity segments for each time of writing across the m number of disk drives 2. / represents a function for obtaining the integer component of a division process. % represents a function for obtaining the remainder component of a division process.

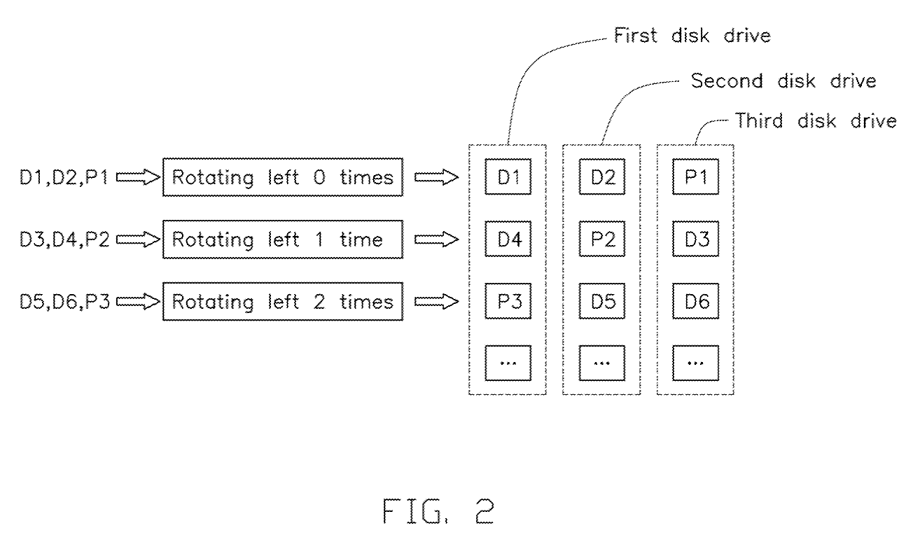

For example, as illustrated in FIG. 2, for a first time of writing across the m number of disk drives 2, the data segments D1 and D2 and the parity segment P1 are written. According to the formula, L=(1/(3−1)*1)%(3*1)=0. Thus, the data segment D1 is written to the first disk drive 2, the data segment D2 is written to the second disk drive 2, and the parity segment P1 is written to the third disk drive 2. For a second time of writing across the m number of disk drives 2, the data segments D3 and D4 and the parity segment P2 are written. According to the formula, L=(3/(3−1)*1)%(3*1)=1. Thus, the disk drive sequence is shifted once to the left, so the data segment D3 is written to the third disk drive 2, the data segment D4 is written to the first disk drive 2, and the parity segment P2 is written to the second disk drive 2. For a third time of writing across the m number of disk drives 2, the data segments D5 and D6 and the parity segment P3 are written. According to the formula, L=(5/(3−1)*1)%(3*1)=2. Thus, the disk drive sequence is shifted twice to the left, so the data segment D5 is written to the second disk drive 2, the data segment D6 is written to the third disk drive 2, and the parity segment P3 is written to the first disk drive 2.

After each time of writing across the m number of disk drives 2, the electronic device 1 can determine whether all of the plurality of data segments and all of the plurality of parity segments of the file have been written. In at least one embodiment, the electronic device 1 determines whether all of the plurality of data segments and all of the plurality of parity segments of the file have been written by recording, through a variable, the number of data segments and the number of parity segments that have been written.

To read the file from the m number of disks 2, the electronic device 1 can transmit a reading command to the m number of disk drives 2 to read the plurality of data segments from the m number of disk drives 2. The electronic device 1 can read the plurality of data segments from the m number of disk drives 2 according to the predetermined reading algorithm. For each time of reading across the m number of disk drives 2, the electronic device 1, according to the predetermined reading algorithm, determines the disk drives 2 to which the corresponding m number of data segments were written according to the serial number of the first one of the m number of data segments, the m number of disk drives 2, and the n number of disk drives 2.

Before each time of reading across the m number of disk drives 2, the electronic device 1 determines whether a remaining number of data segments to be read is less than m. When the remaining number of data segments is not less than m, the electronic device 1 determines, according to the reading algorithm, the disk drives 2 to which the corresponding m number of data segments was written. If the remaining number of data segments is less than m, the electronic device 1 allocates a plurality of dummy data segments to the m number of disk drives 2. For example, the dummy data segments can be allocated to a predetermined position of the disk drives 2 or be allocated to a random position of the disk drives 2.

For each time of reading the m number of disk drives 2, the reading algorithm determines which disk drives 2 of the m number of disk drives 2 to obtain the corresponding m number of data segments according to the formula Addrx=(B+x−1)/(m−n)±(B+x−1)%(m−n).

In the formula, B represents the serial number of a first one of the m number of data segments to be read from the m number of disk drives. m represents the total number of the m number of disk drives. n represents the number of the m number of disk drives used for writing the parity segments for each time of writing across the m number of disk drives. / represents a function for obtaining the integer component of a division process. % represents a function for obtaining the remainder component of a division process. x represents the disk drive number of the m number of disk drives.

For example, when the data segments D4, D5, and D6 need to be read, the reading algorithm can determine that the data segment D4 is stored on the first disk drive 2 according to the formula Addr1=(4+1−1)/(3−1)+(4+1−1)%(3−1)=2+2=4 (D4). Likewise, the reading algorithm can determine that the data segment D5 is stored on the second disk drive 2 according to the formula Addr2=(4+2−1)/(3−1)+(4+2−1)%(3−1)=2+3=5 (D5). Likewise, the reading algorithm can determine that the data segment D6 is stored on the third disk drive 2 according to the formula Addr3=(4+3−1)/(3−1)+(4+3−1)%(3−1)=3+3=6 (D6). Thus, the plurality of data segments can be read from the m number of disks 2 without having to read the plurality of parity segments.

Before each time of assembling the plurality of data segments, the electronic device 1 determines whether a length of the currently assembled plurality of data segments is less than the length of the file. When the length of the currently assembled plurality of data segments is less than the length of the file, the electronic device 1 assembles the current m number of data segments to the currently assembled plurality of data segments. When the length of the currently assembled plurality of data segments is not less than the length of the file, the electronic device 1 deletes an end portion of the assembled plurality of data segments to make the length of the assembled plurality of data segments equal to the length of the file.

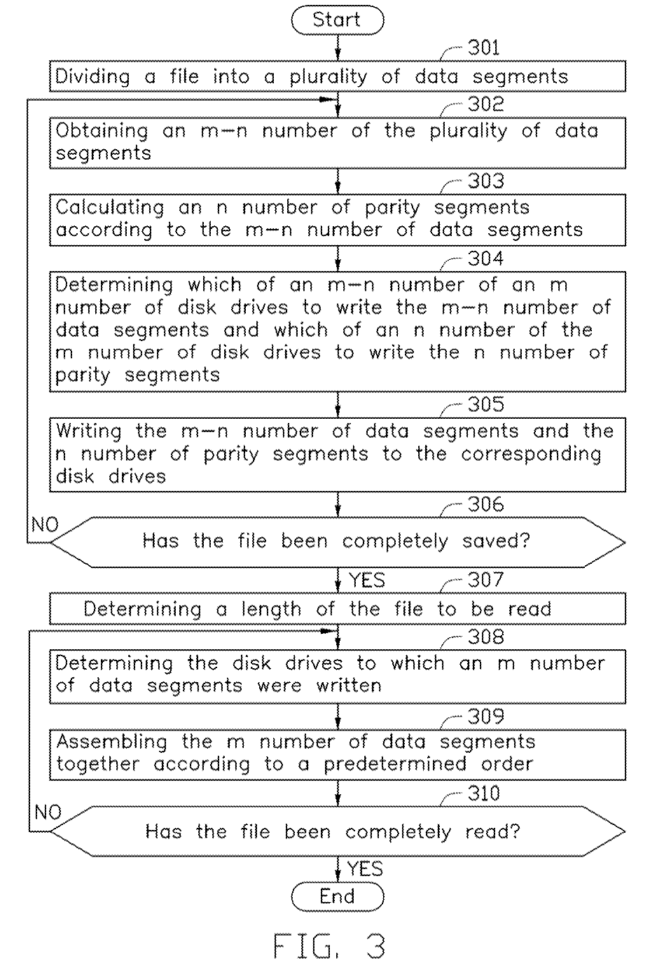

FIG. 3 illustrates a flowchart of an exemplary method for implementing a parity-based RAID method implemented in an electronic device. The method is provided by way of example, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 301.

At block 301, the electronic device can divide a file into a plurality of data segments. In at least one embodiment, each of the plurality of data segments can have a same predetermined size. In at least one embodiment, the predetermined size is 64 kilobytes. The electronic device can determine whether the size of a last one of the plurality of data segments is less than the predetermined size. If the size of the last one of the plurality of data segments is less than the predetermined size, the electronic device can allocate a plurality of dummy data segments to the last one of the plurality of data segments to make the size of the last one of the plurality of data segments equal to the predetermined size. For example, the plurality of dummy data segments can be of a predetermined format, such as being completely made up of binary 0 data.

At block 302, the electronic device can obtain, according to a predetermined sequence, an m−n number of data segments from the plurality of data segments. Before obtaining the m−n number of data segments, the electronic device can determine whether a total number of the plurality of data segments is less than m−n. If the total number of the plurality of data segments is less than m−n, the electronic device can allocate a plurality of dummy data segments to the plurality of data segments to make the total number of the plurality of data segments equal to m−n. For example, the plurality of dummy data segments can be of a predetermined format, such as being completely made up of binary 0 data.

At block 303, the electronic device can calculate a corresponding n number of parity segments according to the m−n number of data segments. The n number of parity segments can be calculated according to a default algorithm.

At block 304, the electronic device can determine which of an m−n number of disk drives to write the m−n number of data segments and which of an n number of the m number of disk drives to write the n number of parity segments according to a serial number of a first one of the m−n number of data segments, the m number of disk drives, and the n number of disk drives. For example, if the file is divided into four data segments D1, D2, D3, and D4, the serial numbers of the data segments are 1, 2, 3, and 4, respectively. The positions of the plurality of data segments stored in the m number of disk drives 2 differ by a predefined file size (64 kilobytes). Thus, by knowing the serial number of the data segments, the positions of the data segments in the m number of disk drives 2 can be determined.

In at least one embodiment, the writing algorithm assigns the m−n number of data segments as B1, B2, . . . , Bm−n and assigns the n number of parity segments as P1, P2, . . . , Pn. The writing algorithm also sequences the m number of disk drives from the first disk drive to the mth disk drive. B1 represents the first data segment of the m−n number of data segments and corresponds to a first disk drive of a disk drive sequence determined by the writing algorithm. Bm−n represents the m−nth data segment of the m−n number of data segments and corresponds to the m−nth disk drive of the disk drive sequence. P1 represents the first parity segment of the n number of parity segments and corresponds to the m−n+1⁴ disk drive of the disk drive sequence. Pn represents the nth parity segment of the n number of parity segments and corresponds to the mth disk drive of the disk drive sequence.

For each time of writing across the m number of disk drives, the writing algorithm determines which disk drives of the m number of disk drives to write the corresponding m−n number of data segments according to the formula L=(B/(m−n)*n)%(m*n).

In the formula, L represents a number of times of moving left along the disk drive sequence relative to a first disk drive of the disk drive sequence. A position located left of the first one of the m number of disk drives is equal to the m^{th} disk drive. B represents the serial number of a first one of the m−n number of data segments to be written across the m number of disk drives. m represents the total number of the m number of disk drives. n represents the number of the m number of disk drives used for writing the parity segments for each time of writing across the m number of disk drives. / represents a function for obtaining the integer component of a division process. % represents a function for obtaining the remainder component of a division process.

For example, for a first time of writing across the m number of disk drives, the data segments D1 and D2 and the parity segment P1 are written. According to the formula, L=(1/(3−1)*1)%(3*1)=0. Thus, the data segment D1 is written to the first disk drive, the data segment D2 is written to the second disk drive, and the parity segment P1 is written to the third disk drive. For a second time of writing across the m number of disk drives, the data segments D3 and D4 and the parity segment P2 are written. According to the formula, L=(3/(3−1)*1)%(3*1)=1. Thus, the disk drive sequence is shifted once to the left, so the data segment D3 is written to the third disk drive, the data segment D4 is written to the first disk drive, and the parity segment P2 is written to the second disk drive. For a third time of writing across the m number of disk drives, the data segments D5 and D6 and the parity segment P3 are written. According to the formula, L=(5/(3−1)*1)%(3*1)=2. Thus, the disk drive sequence is shifted twice to the left, so the data segment D5 is written to the second disk drive, the data segment D6 is written to the third disk drive, and the parity segment P3 is written to the first disk drive.

At block 305, the electronic device writes the plurality of data segments and the plurality of parity segments to the m number of disk drives as determined according to the writing algorithm.

At block 306, the electronic device can determine whether the file has been completely written across the m number of disk drives. When the file has been completely written across the m number of disk drives, block 307 is implemented. Otherwise, when the file has not been completely written across the m number of disk drives, block 302 is implemented. In at least one embodiment, the electronic device determines whether all of the plurality of data segments and all of the plurality of parity segments of the file have been written by recording, through a variable, the number of data segments and the number of parity segments that have been written.

At block 307, the electronic device can determine a length of the file to be read from the m number of disk drives.

At block 308, the electronic device, according to a predetermined reading algorithm, determines the disk drives to which a corresponding m number of data segments were written according to the serial number of a first one of the m number of data segments, the m number of disk drives, and the n number of disk drives.

Before reading across the m number of disk drives, the electronic device can determine whether a remaining number of data segments to be read is less than m. When the remaining number of data segments is not less than m, the electronic device can determine, according to the reading algorithm, the disk drives to which the corresponding m number of data segments was written. If the remaining number of data segments is less than m, the electronic device can allocate a plurality of dummy data segments to the m number of disk drives. For example, the dummy data segments can be allocated to a predetermined position of the disk drives or be allocated to a random position of the disk drives.

For each time of reading the m number of disk drives, the reading algorithm determines which disk drives of the m number of disk drives to obtain the corresponding m number of data segments according to the formula Addrx=(B+x−1)/(m−n)+(B+x−1)%(m−n).

In the formula, B represents the serial number of a first one of the m number of data segments to be read from the m number of disk drives. m represents the total number of the m number of disk drives. n represents the number of the m number of disk drives used for writing the parity segments for each time of writing across the m number of disk drives. / represents a function for obtaining the integer component of a division process. % represents a function for obtaining the remainder component of a division process. x represents the disk drive number of the m number of disk drives.

For example, when the data segments D4, D5, and D6 need to be read, the reading algorithm can determine that the data segment D4 is stored on the first disk drive according to the formula Addr1=(4+1−1)/(3−1)+(4+1−1)%(3−1)=2+2=4 (D4). Likewise, the reading algorithm can determine that the data segment D5 is stored on the second disk drive according to the formula Addr2=(4+2−1)/(3−1)+(4+2−1)%(3−1)=2+3=5 (D5). Likewise, the reading algorithm can determine that the data segment D6 is stored on the third disk drive according to the formula Addr3=(4+3−1)/(3−1)+(4+3-1)%(3−1)=3+3=6 (D6). Thus, the plurality of data segments can be read from the m number of disks without having to read the plurality of parity segments.

At block 309, the electronic device can assemble the m number of data segments together according to a predetermined sequence. Before each time of assembling the m number of data segments, the electronic device can determine whether a length of the currently assembled plurality of data segments is less than the length of the file. When the length of the currently assembled plurality of data segments is less than the length of the file, the electronic device assembles the m number of data segments to the currently assembled plurality of data segments.

At block 310, the electronic device can determine whether the plurality of data segments have been assembled into the file. When the length of the currently assembled plurality of data segments is not less than the length of the file, the electronic device can determine that the plurality of data segments have been assembled into the file. If the length of the plurality of data segments assembled together is greater than the length of the file, the electronic device can delete an end portion of the assembled plurality of data segments to make the length of the assembled plurality of data segments equal to the length of the file.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A system for implementing a parity-based redundant array of independent disks (RAID) method, the system comprising:
an m number of disk drives; and
an electronic device comprising:
a connector configured to couple the m number of disk drives to the electronic device,
a processor, and
a storage configured to store a plurality of instructions for the processor to execute a plurality of functions of the electronic device;
wherein a file is saved to the m number of disk drives by being written across the m number of disk drives one or more times as a plurality of data segments and a corresponding plurality of parity segments;
wherein for each time of writing across the m number of disk drives, an n number of the m number of disk drives are designated for having an n number of the plurality of parity segments written thereto;
wherein for each time of writing across the m number of disk drives, an m−n number of the plurality of data segments are written to a corresponding m−n number of them number of disk drives;
wherein for each time of reading across the m number of disk drives, the electronic device reads an m number of data files;
wherein for each time of reading across the m number of disk drives, the electronic device, according to a predetermined reading algorithm, determines the disk drives to which the m number of data segments were written according to a serial number of a first one of the m number of data segments, the m number of disk drives, and the n number of disk drives;
wherein the electronic device transmits a reading command to each of the m number of disk drives to read the plurality of data segments of the file; and
wherein the electronic device assembles the plurality of data segments together according to a predetermined order, and determines whether all of the data segments have been assembled into the file.

2. The system as in claim 1, wherein:
before each time of the electronic device reading the m number of data segments from the m number of disk drives, the electronic device determines whether a remaining number of the plurality of data segments to be read is less than the m number of disk drives; and
when the remaining number of the plurality of data segments to be read is less than the m number of disk drives, the electronic device allocates one or more dummy data segments to the m number of disk drives to make the remaining number of the plurality of data segments equal to the m number of disk drives.

3. The system as in claim 2, wherein:
when all of the plurality of data segments have been assembled, the electronic device determines whether a length of the assembled data segments is smaller than a length of the file; and
when the length of the assembled data segments is not smaller than the length of the file, the electronic device deletes an end portion of the assembled data segments to make the length of the assembled data segments equal to the length of the file.

4. The system as in claim 1, wherein:
each of the plurality of data segments has the same size;
a sequence of obtaining the m−n number of the data segments for each time of writing across the m number of disk drives is determined by a writing algorithm;
the n number of parity segments is calculated according to the m−n number of data segments;
for each time of writing across the m number of disk drives, the electronic device, according to the predetermined writing algorithm, determines which of the m−n number of disk drives to write the m−n number of data segments and which of the n number of disk drives to write the n number of parity segments according to a serial number of a first one of the m−n number of data segments, the m number of disk drives, and the n number of disk drives; and
after each time of writing the m−n number of data segments and the n number of parity segments across the m number of disk drives, the electronic device determines whether all of the plurality of data segments and all of the plurality of parity segments have been written across the m number of disk drives, and stops writing when it is determined that all of the plurality of data segments and all of the plurality of parity segments have been written across the m number of disk drives.

5. The system as in claim 4, wherein:
before each time of the electronic device writing across them number of disk drives, the electronic device determines whether a remaining number of the plurality of data segments is smaller than m−n; and
when the remaining number of the plurality of data segments is smaller than m−n, the electronic device allocates one or more dummy data segments to the plurality of data segments to make the remaining number of the plurality of data segments equal to m−n.

6. The system as in claim 4, wherein:
the writing algorithm assigns serial numbers to the plurality of data segments as B1, B2, . . . , Bm−n;
the writing algorithm assigns serial numbers to the plurality of parity segments as P1, P2, . . . , Pn;
for each time of writing across the m number of disk drives, the writing algorithm determines which disk drive of the m number of disk drives to write the corresponding m−n number of data segments according to the formula:
L=(B/(m−n)*n)%(m*n);
wherein L represents a number of times of moving left along a disk drive sequence relative to a first disk drive of the disk drive sequence, a position located left of the first one of the m number of disk drives being equal to the m^{th} disk drive;
wherein B represents the serial number of a first one of the m−n number of data segments to be written across the m number of disk drives;
wherein m represents the total number of the m number of disk drives;
wherein n represents the number of the m number of disk drives used for writing the parity segments for each time of writing across the m number of disk drives;
wherein / represents a function for obtaining the integer component of a division process;
wherein % represents a function for obtaining the remainder component of a division process;
for each time of reading across the m number of disk drives, the reading algorithm determines which disk drives of the m number of disk drives to obtain the m number of data segments according to the formula:
Addrx=(B+x−1)/(m−n)+(B+x−1)%(m−n);
wherein B represents the serial number of a first one of the m number of data segments to be read from the m number of disk drives;
wherein m represents the total number of the m number of disk drives;
wherein n represents the number of the m number of disk drives used for writing the parity segments for each time of writing across the m number of disk drives;
wherein / represents a function for obtaining the integer component of a division process;
wherein % represents a function for obtaining the remainder component of a division process; and
wherein x represents the disk drive number of the m number of disk drives.

7. A parity-based redundant array of independent disk drives (RAID) method implemented in an electronic device electrically coupled to an m number of disk drives, the method comprising:
saving, to the m number of disk drives, a file as a plurality of data segments and a corresponding plurality of parity segments by writing the plurality of data segments and the corresponding plurality of parity segments across the m number of disk drives one or more times, each time of writing across the m number of disk drives designating an n number of the m number of disk drives for writing a corresponding n number of parity segments and designating an m−n number of the m number of disk drives for writing a corresponding m−n number of data segments;
wherein for each time of writing across the m number of disk drives, an m−n number of the data segments is written to a corresponding m−n number of the m number of disk drives,
determining, by the electronic device according to a predetermined reading algorithm, the disk drives to which a corresponding m number of data segments were written according to a serial number of a first one of the m number of data segments, the m number of disk drives, and the n number of disk drives;
transmitting, by the electronic device, a reading command to each of the m number of disk drives to read the corresponding m number of data segments of the file;
reading, by the electronic device, the m number of disk drives one or more times to obtain the corresponding m number of data segments of the file;
assembling, by the electronic device, each of the m number of data segments together according to a predetermined order; and
determining, by the electronic device, whether all of the plurality of data segments have been assembled into the file.

8. The method as in claim 7, wherein:
before each time of the electronic device reading the m number of data segments from the m number of disk drives, the electronic device determines whether a remaining number of the plurality of data segments to be read is less than the m number of disk drives; and
when the remaining number of the plurality of data segments to be read is less than the m number of disk drives, the electronic device allocates one or more dummy data segments to the m number of disk drives to make the remaining number of the plurality of data segments equal to the m number of disk drives.

9. The method as in claim 8, wherein:
when all of the plurality of data segments have been assembled, the electronic device determines whether a length of the assembled data segments is smaller than a length of the file; and
when the length of the assembled data segments is not smaller than the length of the file, the electronic device deletes an end portion of the assembled data segments to make the length of the assembled data segments equal to the length of the file.

10. The method as in claim 7, wherein:
each of the plurality of data segments has the same size;
a sequence of obtaining the m−n number of the data segments for each time of writing across the m number of disk drives is determined by a writing algorithm;
the n number of parity segments is calculated according to the m−n number of data segments;
for each time of writing across the m number of disk drives, the electronic device, according to the predetermined writing algorithm, determines which of the m−n number of disk drives to write the m−n number of data segments and which of the n number of disk drives to write the n number of parity segments according to a serial number of a first one of the m−n number of data segments, the m number of disk drives, and the n number of disk drives;
after each time of writing the m−n number of data segments and the n number of parity segments across the m number of disk drives, the electronic device determines whether all of the plurality of data segments and all of the plurality of parity segments have been written across the m number of disk drives, and stops writing when it is determined that all of the plurality of data segments and all of the plurality of parity segments have been written across the m number of disk drives.

11. The method as in claim 10, wherein:
before each time of the electronic device writing across them number of disk drives, the electronic device determines whether a remaining number of the plurality of data segments is smaller than m−n; and
when the remaining number of the plurality of data segments is smaller than m−n, the electronic device allocates one or more dummy data segments to the plurality of data segments to make the remaining number of the plurality of data segments equal to m−n.

12. The method as in claim 10, wherein:
the writing algorithm assigns serial numbers to the plurality of data segments as B1, B2, . . . , Bm−n;
the writing algorithm assigns serial numbers to the plurality of parity segments as P1, P2, . . . , Pn;
for each time of writing across the m number of disk drives, the writing algorithm determines which disk drive of the m number of disk drives to write the corresponding m−n number of data segments according to the formula:
L=(B/(m−n)*n)%(m*n);
wherein L represents a number of times of moving left along a disk drive sequence relative to a first disk drive of the disk drive sequence, a position located left of the first one of the m number of disk drives being equal to the m^{th} disk drive;
wherein B represents the serial number of a first one of the m−n number of data segments to be written across the m number of disk drives;
wherein m represents the total number of the m number of disk drives;
wherein n represents the number of the m number of disk drives used for writing the parity segments for each time of writing across the m number of disk drives;
wherein / represents a function for obtaining the integer component of a division process;
wherein % represents a function for obtaining the remainder component of a division process;
for each time of reading across the m number of disk drives, the reading algorithm determines which disk drives of the m number of disk drives to obtain the m number of data segments according to the formula:
Addrx=(B+x−1)/(m−n)+(B+x−1)%(m−n);
wherein B represents the serial number of a first one of the m number of data segments to be read from the m number of disk drives;
wherein m represents the total number of the m number of disk drives;
wherein n represents the number of the m number of disk drives used for writing the parity segments for each time of writing across the m number of disk drives;
wherein / represents a function for obtaining the integer component of a division process;
wherein % represents a function for obtaining the remainder component of a division process; and
wherein x represents the disk drive number of the m number of disk drives.
